(19) United States
(12) Patent Application Publication
(10) Pub. No.: US 2024/0088584 A1
(43) Pub. Date: Mar. 14, 2024

(54) APPLIANCE SOCKET

(71) Applicant: HARTING ELECTRIC STIFTUNG & CO. KG, Espelkamp (DE)

(72) Inventors: Wilhelm KLIEVER, Minden (DE); Florian HACKEMEIER, Rahden (DE)

(21) Appl. No.: 18/274,186

(22) PCT Filed: Feb. 28, 2022
(86) PCT No.: PCT/DE2022/100166

§ 371 Date: Jul. 25, 2023

(30) Foreign Application Priority Data
Mar. 12, 2021 (DE) 10 2021 106 018.4

(51) Int. Cl. H01R 12/58; H01R 12/52; H01R 12/70; H01R 13/41

(52) U.S. Cl. CPC H01R 12/585; H01R 12/523; H01R 12/7023; H01R 13/41

(57) ABSTRACT

An appliance socket configured to be electrically mounted on a printed circuit board without soldering has a plug housing, a contact carrier, an insulation body and at least one contact element. The contact element is arranged in the contact carrier and is substantially cylindrical. The contact element has a contact area for electrically contacting a mating contact element of a mating plug, and a connection area for electrical connection to a conductor track of the printed circuit board; and the connection area of the contact element has an axial slot. Also disclosed is to a system composed of an electrical appliance and an appliance socket as above described wherein: the electrical appliance has a housing having an appliance wall and at least one printed circuit board arranged within the housing. The contact carrier of the appliance socket is fixed to the printed circuit board and is located within the housing of the electrical appliance; and the plug housing is located on the outer face of the housing wall and is located outside of the housing of the electrical appliance.

The invention is based on an appliance socket according to the generic type of the independent claim 1. The invention relates further to an electrical appliance which uses such an appliance socket, according to the generic type of the subordinate claim 11.

Appliance sockets are sufficiently well known. They are needed in particular to supply electronic components on a printed circuit board with electric signals and/or electric currents. The appliance sockets have contact elements which, on the connection side, are electrically conductively contacted to a printed circuit board. As a rule, the contact elements are soldered to so-called contact pads of the printed circuit board for this purpose.

Printed circuit boards are used in various electrical appliances. Here, it is in particular necessary to create connection areas which supply the printed circuit board with electrical energy. Provided for this purpose are appliance sockets which, in the industrial environment, are subjected to high mechanical stresses.

### PRIOR ART

DE 10 2008 007 310 A1 shows a contact element which can be contacted on a printed circuit board without solder. For this purpose, the contact element has a contact area which is similar to the eye of a needle, which is plugged into a corresponding contact opening, which electrically functionally is designed in a way analogous to the contact pad, and latches mechanically there.

Contact elements of this type are, however, particularly susceptible to vibration, so that they cannot be used for many industrial applications and corresponding appliances. In addition, such contact elements are limited in their current carrying capacity, in particular because of their flat geometry, so that they are ruled out for an energy supply of an industrial electrical appliance. In particular, such contact elements are unsuitable for grounding the electrical appliance.

Appliance sockets in which contact elements are used for the connection to a printed circuit board often have little protection against the penetration of media (specified in various IP classes).

In the priority application relating to the present application, the German Patent and Trademark Authority has researched the following prior art: WO 2019/072336 A1, DE 10 2017 127 482 A1, DE 42 16 809 C2, EP 0 132 664 B1 and DE 94 14 143 U1.

### Object of the Invention

The object of the invention consists in proposing an appliance socket which reduces the above disadvantages. In particular, the intention is to propose an appliance socket which is vibration-proof and simple to install and which exhibits good tightness counter to the penetration of media such as dust and water.

The object is achieved by the subject matter of the independent claims.

Advantageous refinements of the invention are specified in the sub-claims and the following description.

The appliance socket according to the invention is provided for tool-free and in particular solder-free electrical connection to a printed circuit board. The appliance socket and its contact elements can be mounted on the printed circuit board without tools.

The appliance socket has a plug connector housing, a contact carrier, an insulation body and at least one contact element. The appliance socket according to the invention is used in particular as a socket for an electrical appliance in the industrial environment. Therefore, the contact carrier and the insulation body are provided explicitly as separate and different components.

As a rule, such an appliance socket has a plurality of contact elements, which in particular are designed identically. If, in the following text, mention is made of a property of the contact element, this property can of course be transferred to a plurality of contact elements in each case.

The contact element is arranged in the contact carrier or fixed therein and is substantially cylindrical. Here, the radius of the cylinder cross section can vary along the axial extent of the contact element.

The contact element is preferably solid, that is to say made of solid material, is milled out and is therefore suitable to transmit high currents.

The contact element has a contact area, which is provided for electrically contacting a mating contact element of a mating plug connector. The contact area points in the plug-in direction of the appliance socket. The contact element has a connection area, which is provided for the electrical connection to a conductor track of the printed circuit board. The connection area of the contact element points in a corresponding way in the connection direction of the appliance socket.

The printed circuit board has a contact opening, which is surrounded or encased with electrically conductive material. This material is in turn connected to a conductor track of the printed circuit board.

The connection area of the contact element has an axial gap or an axial slit. It is also possible to say that the gap extends axially into the contact element. The gap or slit has a length which corresponds to one quarter to one third of the length of the entire contact element.

Preferably, the connection area of the contact element has an axial gap with a cross-shaped cross section. The spring elements formed by the gap can easily be bent radially outward. As the contact area is inserted into the contact opening of the printed circuit board, the contact elements, besides making the electrical contact, are also mechanically fixed and stabilized on the printed circuit board by the spring elements and the spring force of the latter. The diameter of the contact element is matched to the diameter of the associated contact opening.

The appliance socket has a connection side and a plug-in side. The connection area of the contact element on the connection side projects out of the appliance socket. As a result, the appliance socket can be plugged simply onto the printed circuit board and the contact elements can be aligned with the associated contact openings.

Preferably, the appliance socket has at least one further contact element, which is designed as a PE contact element (PE=Protection Earth). This contact element is connected to the ground potential. A PE contact element is advantageous if higher currents are also transferred from a plug connector or its current-carrying contact elements. The PE contact element can technically be designed in exactly the same way as the other contact elements of the appliance socket.

Advantageously, the contact carrier forms substantially cylindrical contact chambers. A respective contact element is arranged in the contact chambers and also mechanically fixed therein. The contact chambers each have an inwardly directed radially circumferential web. Matching this, the contact element has or the contact elements each have a radially circumferential groove. The web of a contact element engages in the groove of an associated contact chamber, by which means the contact elements are fixed in the contact carrier.

Preferably, the contact carrier has latching means, with which it is mechanically fixed on or to the printed circuit board. The latching means is advantageously a latching hook pointing in the connection direction, which reaches through a latching opening which is provided for it in the printed circuit board, and is subsequently supported on the rear side of the printed circuit board. As a result, the contact carrier performs a stabilizing function and thus effects higher resistance to vibration and tensile loading.

Advantageously, the contact elements are straight. This means that the contact elements are not curved or bent along their axial extent. The insertion and withdrawal forces can be absorbed simply by the contact carrier as a result. In addition, the electrical appliance can be constructed more simply and more compactly.

### EXEMPLARY EMBODIMENT

An exemplary embodiment of the invention is illustrated in the drawings and will be explained in more detail below. In the drawings:

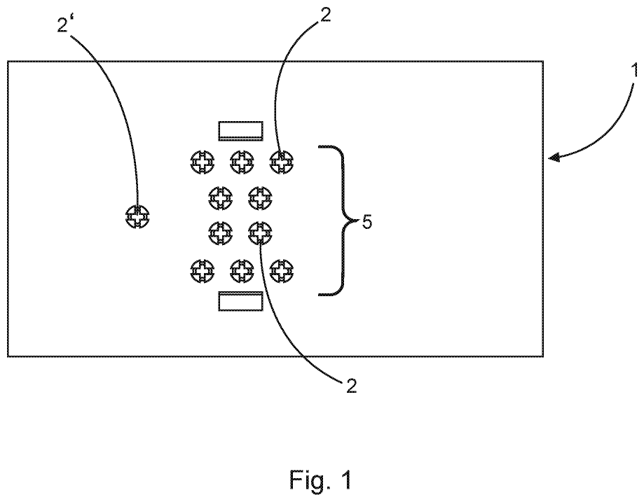

FIG. 1 shows a printed circuit board having a mounting space for an appliance socket according to the invention,

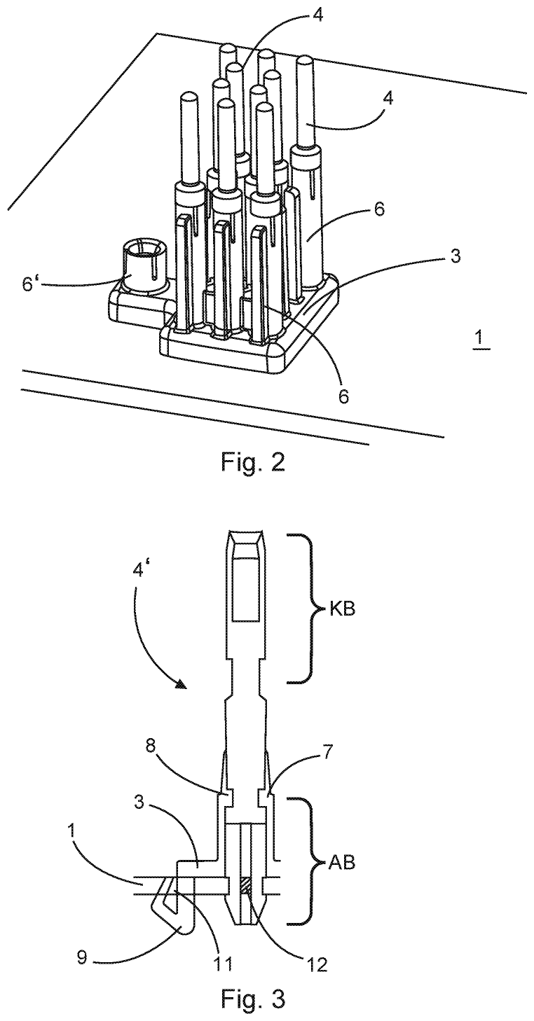

FIG. 2 shows a contact carrier of the appliance socket according to the invention, which is latched to the printed circuit board,

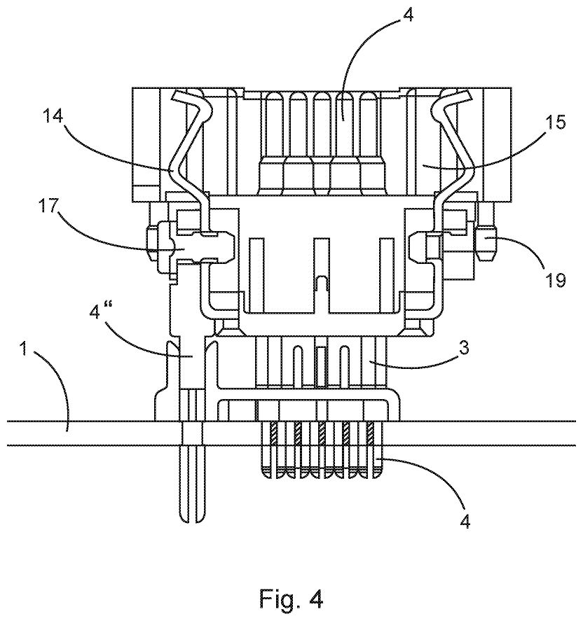

FIG. 3 shows a sectional illustration of a contact element of the appliance socket according to the invention,

FIG. 4 shows a sectional illustration of the appliance socket according to the invention (without plug connector housing), which is mounted on the printed circuit board,

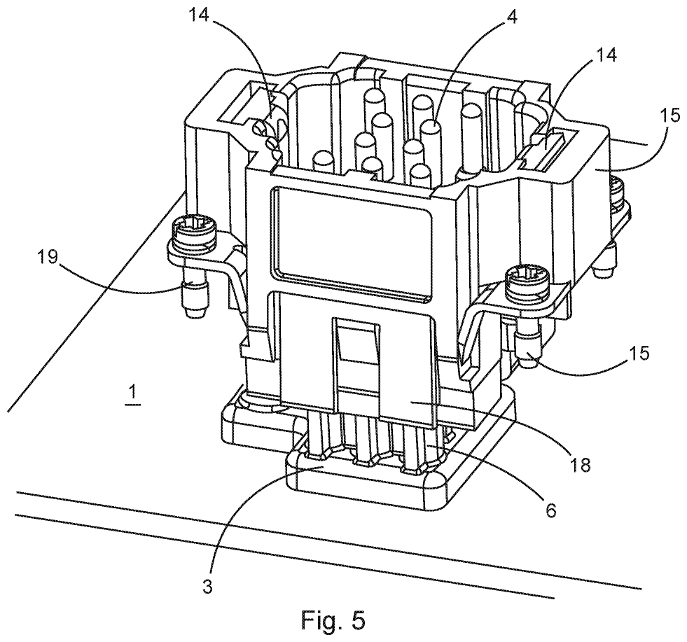

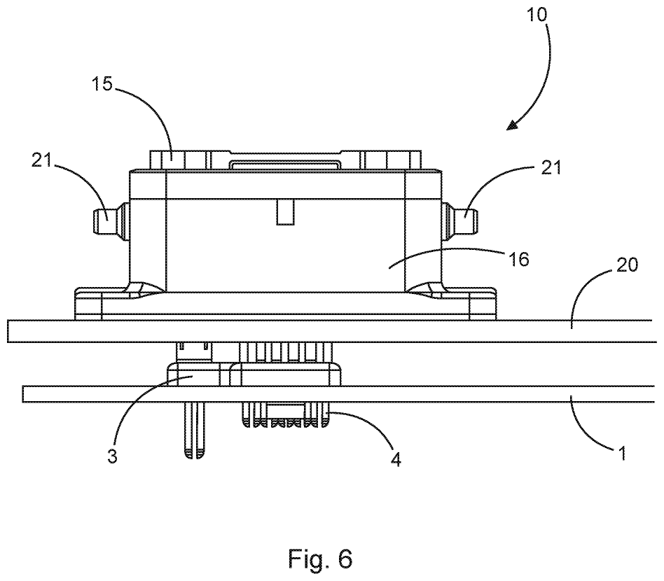

FIG. 5 shows a perspective illustration of the appliance socket according to the invention (without plug connector housing), which is mounted on the printed circuit board, and

FIG. 6 shows a side view of the appliance socket installed on an electrical appliance.

The figures contain partially simplified schematic illustrations. To some extent, identical designations are used for similar but possibly not identical elements. Various views of the same elements may be scaled differently.

FIG. 1 shows a detail of a printed circuit board 1 with an example of a mounting space 5 for an appliance socket according to the invention. In this exemplary embodiment, the mounting space 5 is composed of substantially ten contact openings 2, which are provided for the electrical connection of the contact elements 4 of the appliance socket 10. In addition, the mounting space has a contact opening 2′ for a PE contact element. The number and geometric orientation of the contact openings 2, 2′ corresponds to the corresponding contact geometry of the appliance socket 10 and can also be configured otherwise than shown here. The contact openings 2, 2′ are encased along their rim with a conductive layer, which is in turn electrically conductively connected to at least one conductor track (not shown) of the printed circuit board 1.

The contact openings 2, 2′ are matched to the connection area AB of the contact element 4, 4′, 4″ and, in this exemplary embodiment, have a substantially cross-shaped or else clover leaf-shaped outline.

FIG. 2 reveals a contact carrier 3 of the appliance socket 10 that is mounted on the printed circuit board 1. The contact elements 4 are fixed in the contact carrier 10. Here, these are what are known as pin contact elements. Alternatively the contact elements 4 can of course also be designed as socket contact elements 4′, as can be seen in FIG. 3.

The contact elements 4, 4′ each have a contact area KB for making electric contact with a mating contact element of a mating plug connector (not shown), and a connection area AB for electrical connection to a conductor track (not shown) of the printed circuit board 1.

The connection area AB of the contact element 4 has an axial gap 12 with a cross-shaped cross section. The diameter of the contact openings 2 is matched to the diameter of the connection area AB of the contact element 4. The diameter of the contact opening 2 is ideally somewhat smaller than the diameter of the connection area. As a result—when the respective contact element 4 is inserted into the associated contact opening 2—the lugs formed by the gap are forced radially inward. As a result of the subsequent opposing pressure of the lugs against the metallized rim area of the contact openings 2, the contact element 4, 4′ is reliably electrically contacted on the printed circuit board 1.

The contact carrier 3 has contact chambers 6, in each of which a contact element 4 is fixed. For this purpose, the contact element 4 has a circumferential groove 8, in which a circumferential web 7, which extends within the contact chamber 6, engages. As a result the contact elements 4, 4′, 4″ are secured and fixed in the contact carrier, in particular also against an excessively high tensile stress.

The contact carrier 3 has a latching hook 9 projecting in the connection direction, which can be led through a corresponding latching opening 11 in the printed circuit board 1 and latches on the rear side of the printed circuit board 1. As a rule, two or more such latching hooks 9 and latching openings 11 are provided, which are not shown merely for illustrative reasons. As a result, not only can the contact elements 4, 4′, 4″ be contacted electrically on the printed circuit board without solder, but the contact carrier 3 can also be mounted on the same without any tools.

In FIG. 4, it can be seen that an insulation body 15 is connected or latched to the contact carrier 3. The latching is realized by a latching element 18 shown in FIG. 5. By means of the insulation body 15, the contact elements 4, 4′ are shielded from the plug connector housing 16. In addition, this also ensures the maintenance of the required air and creep distances at the underlying currents. A PE metal sheet 14 is arranged on both sides in the insulation body 15. By means of the PE metal sheets, a transfer of ground potential to a mating plug connector (not shown) is ensured. One of the PE metal sheets 14 is electrically connected to the PE contact element 4″ via a screw 17.

In FIG. 6, the appliance socket 10 is shown in its proper area of use. As described above, the contact elements 4, 4′, 4″ on the printed circuit board 1 are electrically contacted. The contact carrier 3 is latched and fixed on the printed circuit board 1. An appliance wall 20 of an electrical appliance (not shown) is arranged parallel to the printed circuit board 1. The printed circuit board 1 together with the contact carrier 3 is located within the electrical appliance. The contact elements 4, 4′, 4″ together with the insulation body 15 project through the appliance wall 20 to the outside through an opening in the appliance wall 20, not shown for illustrative reasons. The insulation body 15 is covered by a plug connector housing 16, which is fixed to the appliance wall 20 via the screws 19.

The plug connector housing 16 has a substantially rectangular cross section based on the viewing direction in FIG. 6. On its narrow sides, the plug connector housing 16 has locking pins 21, over which a locking clip (not shown) of a mating plug connector can engage in order to lock a plug connection comprising appliance socket 10 and matching mating plug connector reversibly together.

Even though different aspects or features of the invention are each shown in combination in the figures, it will be obvious to those skilled in the art—if not otherwise specified—that the combinations illustrated and discussed are not the only ones possible. In particular, mutually corresponding units or feature combinations of different exemplary embodiments can be interchanged with one another.

### LIST OF DESIGNATIONS

1 Printed circuit board
2 Contact opening
3 Contact carrier
4 Contact element
5 Mounting space
6 Contact chamber
7 Web within the contact chamber 6
8 Groove in the contact element 4
9 Latching hook of the contact carrier 3
10 Appliance socket
11 Latching opening in the printed circuit board 1
12 Axial gap in the connection area AB of the contact element 4
14 PE metal sheet
15 Insulation body
16 Plug connector housing
17 Screw
18 Latching element
19 Screw
20 Appliance wall
21 Locking pin
AB Connection area of the contact element 4
KB Contact area of the contact element 4

1. An appliance socket for electrically contacting a printed circuit board without solder,
wherein the appliance socket has a plug connector housing, a contact carrier, an insulation body and at least one contact element,
wherein the contact element is arranged in the contact carrier and is substantially cylindrical,
wherein the contact element has a contact area for electrically contacting a mating contact element of a mating plug connector, and a connection area for electrically connecting to a conductor track of the printed circuit board,
wherein the connection area of the contact element has an axial gap.

2. The appliance socket as claimed in claim 1, wherein
the appliance socket has a connection side and a plug-in side, and in that the connection area of the contact element projects out of the appliance socket on the connection side.

3. The appliance socket as claimed in claim 1, wherein
the connection region of the contact element has an axial gap with a cross-shaped cross section.

4. The appliance socket as claimed in claim 1, wherein
the appliance socket has at least one further contact element, which is designed as a PE contact element.

5. The appliance socket as claimed in claim 1, wherein
the contact carrier has a latch which is configured to be mechanically fixed on the printed circuit board.

6. The appliance socket as claimed in claim 1, wherein
the contact carrier forms substantially cylindrical contact chambers, in each of which a contact element is arranged and mechanically fixed.

7. The appliance socket as claimed in claim 6, wherein
the contact chambers have an inwardly directed radially circumferential web.

8. The appliance socket as claimed in claim 1, wherein
the contact element or the contact elements has/have a radially circumferential groove.

9. The appliance socket as claimed in claim 6, wherein
the web of the contact chamber is configured to engage in the groove of an associated contact element, by which the contact elements are fixed in the contact carrier.

10. The appliance socket as claimed in claim 1, wherein
the contact elements are straight.

11. An electrical appliance having an appliance socket as claimed in claim 1, wherein the electrical appliance has a housing with an appliance wall and at least one printed circuit board arranged within the housing,
wherein the contact carrier of the appliance socket is fixed on the printed circuit board and is located within the housing of the electrical appliance,
and wherein the plug connector housing is arranged on the outer side of the appliance wall and is located outside the housing of the electrical appliance.

12. The electrical appliance as claimed in claim 11, wherein
the printed circuit board and the appliance wall are aligned parallel to each other.

13. The appliance socket as claimed in claim 9, wherein
the contact elements are straight.

14. The appliance socket as claimed in claim 7, wherein
the web of the contact chamber is configured to engage in the groove of an associated contact element, by which the contact elements are fixed in the contact carrier.

15. The appliance socket as claimed in claim 14, wherein
the contact elements are straight.

16. The appliance socket as claimed in claim 8, wherein
the web of the contact chamber is configured to engage in the groove of an associated contact element, by which the contact elements are fixed in the contact carrier.

17. The appliance socket as claimed in claim 16, wherein
the contact elements are straight.

18. The appliance socket as claimed in claim 2, wherein
the connection region of the contact element has an axial gap with a cross-shaped cross section.

19. The appliance socket as claimed in claim 2, wherein
the appliance socket has at least one further contact element, which is designed as a PE contact element.

20. The appliance socket as claimed in claim 1, wherein
the contact carrier has a latch which is configured to be mechanically fixed on the printed circuit board.
